(19) United States
(12) Patent Application Publication
(10) Pub. No.: US 2009/0022412 A1
(43) Pub. Date: Jan. 22, 2009

(54) IMAGE PROCESSING APPARATUS AND IMAGE PICKUP APPARATUS USING THE SAME

(75) Inventor: Shigeyuki OKADA, Ogaki-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 12/172,621

(22) Filed: Jul. 14, 2008

(30) Foreign Application Priority Data
Jul. 20, 2007 (JP) 2007-189722
Jul. 20, 2007 (JP) 2007-189723

(51) Int. Cl. G06K 9/36

(52) U.S. Cl. 382/240

(57) ABSTRACT

A hierarchical coding unit hierarchically codes picked-up moving images. A storage stores moving image coded data which have been coded by the hierarchical coding unit. A hierarchical decoding unit decodes part of the moving image coded data so as to generate a moving image whose image quality is lower than the moving images. A recoding unit codes the moving image decoded by the hierarchical decoding unit. The hierarchical decoding unit decodes the moving image coded data starting from a lowest hierarchy up to a hierarchy corresponding to a specified resolution.

### CROSS-REFERENCE TO RELATED APPLICATIONS

This application is based upon and claims the benefit of priority from the prior Japanese Patent Applications No. 2007-189723, filed on Jul. 20, 2007, and Japanese Patent Application No. 2007-189722, filed on Jul. 20, 2007, the entire contents of which are incorporated herein by reference.

### BACKGROUND OF THE INVENTION

1. Field of the Invention

The present invention relates to an image processing apparatus for coding moving images and an image pickup apparatus using the same.

2. Description of the Related Art

Digital movie cameras have been used widely. The effective pixels of digital movie cameras are increasing every year, and those featuring full high-definition (HD) resolution are now put to practical use. At the same time, there have been a great variety of equipment and devices available for playing back moving images shot by the digital movie cameras. The moving images can be reproduced not only by TV receivers but also by mobile phones, mobile music players, portable information terminals such as PDAs (Personal Digital Assistants), PCs, projectors and the like.

Among these devices, the display size and the display specifications differ greatly between an HDTV and a mobile phone. For instance, the image size defined by 1080i of 1920×1080 pixels or 1125i of 1920×1080 pixels can be displayed by the HDTV. On the other hand, it is difficult for the mobile phone to display images whose resolution is higher than that of QVGA (Quarter Video Graphics Array) of 320×240 pixels or VGA of 640×480 pixels.

The moving images picked up with high image quality by the digital movie camera can be played back directly by the HDTV. However, if these high quality images are to be played back by the mobile phone, they must undergo recompression and recoding in order to be adjusted to the display specifications therefor.

The moving images picked up by the digital movie camera are generally compressed and coded in compliance with the standard of MPEG (Moving Picture Experts Group)-2, MPEG-4, or H.264/AVC. In order for a portable information terminal to reproduce the moving images picked up with high image quality by the digital movie camera, data of the moving images need to be once retrieved into a PC and then recompressed and recoded again. Then the moving image coded data which have been recompressed and recoded need to be handed over to the portable information terminal via a communication medium or recording medium.

For example, in a case when the moving image coded data (hereinafter referred to as “H.264-compressed data” as appropriate) which have been picked up with 1920×1080 pixels and have been compressed and coded in compliance with the H.264/AVC standard are to be recompressed and recoded to H.264-compressed data of 640×480 pixels, the following processes must be taken. That is, the H.264-compressed data of 1920×1080 pixels are once expanded and decoded; the decoded image of 1920×1080 pixels is converted to an image of 640×480 pixels using a predetermined thinning-out processing or the like; and the thus converted image needs to be recompressed and recoded in compliance with the H.264/AVC standard.

In this manner, extra time and effort for loading the moving images into the PC and additional time for recompressing and recoding them are needed before handing those moving images picked up with high image quality over to a device, which displays the moving images with low image quality, in a reproducible state.

### SUMMARY OF THE INVENTION

An image processing apparatus according to one embodiment of the present invention comprises: a hierarchical coding unit which hierarchically codes a picked-up moving image; a storage which stores moving image coded data which have been coded by the hierarchical coding unit; a hierarchical decoding unit which decodes part of the moving image coded data so as to generate a moving image whose image quality is lower than the moving image; and a recoding unit which codes the moving image decoded by the hierarchical decoding unit.

Optional combinations of the aforementioned constituting elements, and implementations of the invention in the form of methods, apparatuses, systems, recording media, computer programs and the like may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 illustrates a structure of an image pickup apparatus according to a first embodiment of the present invention;

FIG. 2 illustrates a structure of a moving image codestream CS coded by a hierarchical coding unit;

FIG. 3 illustrates a structure of an image pickup apparatus according to a second embodiment of the present invention;

FIG. 4 illustrates a structure of an image pickup apparatus according to a third embodiment of the present invention; and

FIG. 5 shows an example of moving images where regions of interest are set in the moving images.

### DETAILED DESCRIPTION OF THE INVENTION

The invention will now be described by reference to the preferred embodiments. This does not intend to limit the scope of the present invention, but to exemplify the invention.

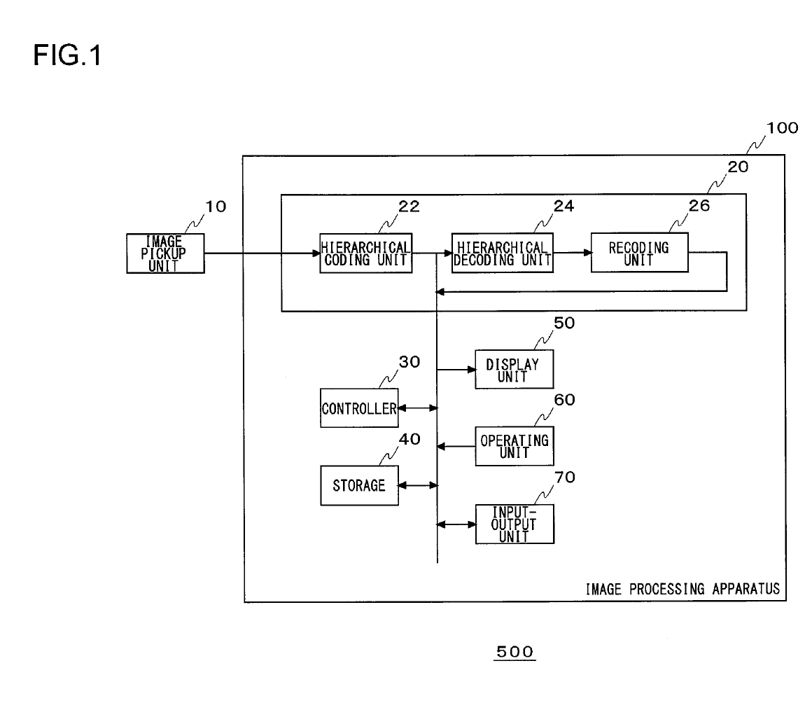

FIG. 1 illustrates a structure of an image pickup apparatus 500 according to a first embodiment of the present invention. The image pickup apparatus 500 includes an image pickup unit 10, an image processing apparatus 100. The image processing apparatus 100 includes a coding unit 20, a controller 30, a storage 40, a display unit 50, an operating unit 60, and an input-output unit 70. The coding unit 20 includes a hierarchical coding unit 22, a hierarchical decoding unit 24, and a recoding unit 26.

The structure including the coding unit 20, the controller 30 and the storage 40 may be implemented hardwarewise by elements such as any DSP, memory and other LSIs, and softwarewise by memory-loaded programs or the like having an image coding function. Depicted herein are functional blocks implemented by cooperation of hardware and software. Therefore, it will be obvious to those skilled in the art that the functional blocks may be implemented by a variety of manners including hardware only, software only or a combination of both.

The image pickup unit 10 includes image pickup devices, such as CCD (Charge-Coupled Device) sensors and CMOS (Complementary Metal-Oxide Semiconductor) image sensors, and a signal processor (not shown) for processing the signals photoelectrically converted by the CCDs. The signal processor converts analog signals from the image pickup devices into digital signals so as to be outputted to the image processing apparatus 100. Assume in the present embodiment that the image pickup unit 10 picks up images with resolution defined by 1080i (1920×1080 pixels).

Moving image signals outputted from the image pickup unit 10 are inputted to the hierarchical coding unit 22 in the coding unit 20. The hierarchical coding unit 22 hierarchically codes the moving image signals. That is, the moving image signals are compressed and coded in a scalable video coding (SVC) format. The hierarchical coding is a technique where coding is performed from coarse information to fine information in stages. Hence, by implementing this coding technique, a plurality of images having different resolutions or bit rates can be generated from a single stream of hierarchically coded data.

The moving image coded data which have been hierarchically coded by the hierarchical coding unit 22 are stored in the storage 40. Here, any one of temporal hierarchical coding, spatial hierarchical coding and SNR (Signal-to-Noise Ratio) hierarchical coding may be used regardless of the kinds of hierarchical codings used.

In the present embodiment, the hierarchical coding unit 22 performs hierarchical coding so that images with resolutions of versatile standards can be generated. For instance, performed is the hierarchical coding where an image of QVGA size (320×240 pixels) is generated by decoding the lowest hierarchy and a hierarchy one level above this lowest hierarchy (hereinafter referred to as “second lowest hierarchy” also) and an image of VGA size (640×480 pixels) is generated by decoding a hierarchy one level above the second lowest hierarchy.

It is assumed in the present embodiment that the images undergo the spatial hierarchical coding using the H.264/SVC standard, which is supported as a extended function of the H.264/AVC standard. In the H.264/SVC standard, the hierarchical coding is performed. Thus, a coder using the H.264/AVC standard is provided for each hierarchy, and the moving images of different resolutions are inputted to the coders. Each coder carries out motion estimation, motion compensation, frequency conversion, quantization and entropy coding. In so doing, inter-hierarchy prediction is made, thereby further enhancing the compression efficiency. Finally, a multiplexer multiplexes the coded data of the respective hierarchies. The lowest-hierarchy coded data in the coded data which have been hierarchical coded using the H.264/SVC standard are compatible with the H.264/AVC standard.

The control unit 30 controls the image processing apparatus 100 as a whole. Particularly in the present embodiment, when the moving image coded data stored in the storage 40 are decoded by the hierarchical decoding unit 24, a hierarchy to be decoded is specified to the hierarchical decoding unit 24. The resolution of images to be recompressed and recoded (transcoded) is specified to the controller 30 through instructions from the operating unit 60 based on a user operation. A hierarchy to be decoded is identified based on this resolution and is specified to the hierarchy decoding unit 24. For example, the control unit 30 has selection screens, such as “1080i→QVGA”, “1080i→VGA” and the like, displayed by the display unit 50. The user operates on the operating unit 60 to select any one of such recompressing and recoding (transcoding) methods.

If the input-output unit 70 and a device to which the moving images are to be transferred are connected through a cable or the like, the display specifications may be acquired from this device and the resolution of images to be recompressed and recoded may be identified. This processing will be performed prior to the transfer processing.

The storage 40, equipped with a recording medium such as a flash memory and a hard disk, stores the moving image coded data coded by the hierarchical coding unit 22. The storage 40 may be built into the image pickup apparatus 500 or may be provided within a docking station or a cradle to which the image pickup apparatus 500 is connected.

The display unit 50, provided with a liquid crystal display, displays the picked-up moving images, various kinds of commands to be selected by a user, or the like. The operating unit 60, provided with various kinds of switches and buttons, conveys user's decision on an operation to the controller 30.

The input-output unit 70 is an interface with an external elements. The input-output unit 70 is connected to an external device or devices via a wired or wireless communication medium. For example, the input-output unit 70 may be connected to a TV receiver via a high-definition multimedia interface (HDMI) cable or connected to a PC via a universal serial bus (USB) cable. The input-output unit 70 is also provided with a slot fitted with detachable recording medium such as a memory card, a USB memory or a DVD. It is to be noted that the input-output unit 70 may be provided in the body of the image pickup apparatus 500 or may be provided within a docking station or a cradle to which the image pickup apparatus 500 is connected.

The hierarchical decoding unit 24 decodes part of the moving image coded data stored in the storage 40 and then generates moving images whose image quality is lower than the picked-up moving images. The hierarchical decoding unit 24 decodes the coded data from the lowest hierarchy up to a hierarchy corresponding to the resolution specified by the controller 30, in the moving image coded data which have been hierarchically coded. For example, when the VGA size (640×480 pixels) is specified by the controller 30, the hierarchical decoding unit 24 decodes the coded data from the lowest hierarchy up to a hierarchy necessary for generating the VGA size. Upon receiving a write instruction to a detachable recording medium or an transfer instruction to an external device from the controller 30, the hierarchical decoding unit 24 carries out the above-described processing.

The recoding unit 26 once again codes the moving images decoded by the hierarchical decoding unit 24. In the present embodiment, the moving images are compressed and coded according to the 264/AVC standard. By following an instruction from the controller 30, the recoding unit 26 transfers the coded H.264-compressed data to the external device or writes them to a removable recording medium via the input-output unit 70. It is to be noted that said H.264-compressed data may be stored in the storage 40.

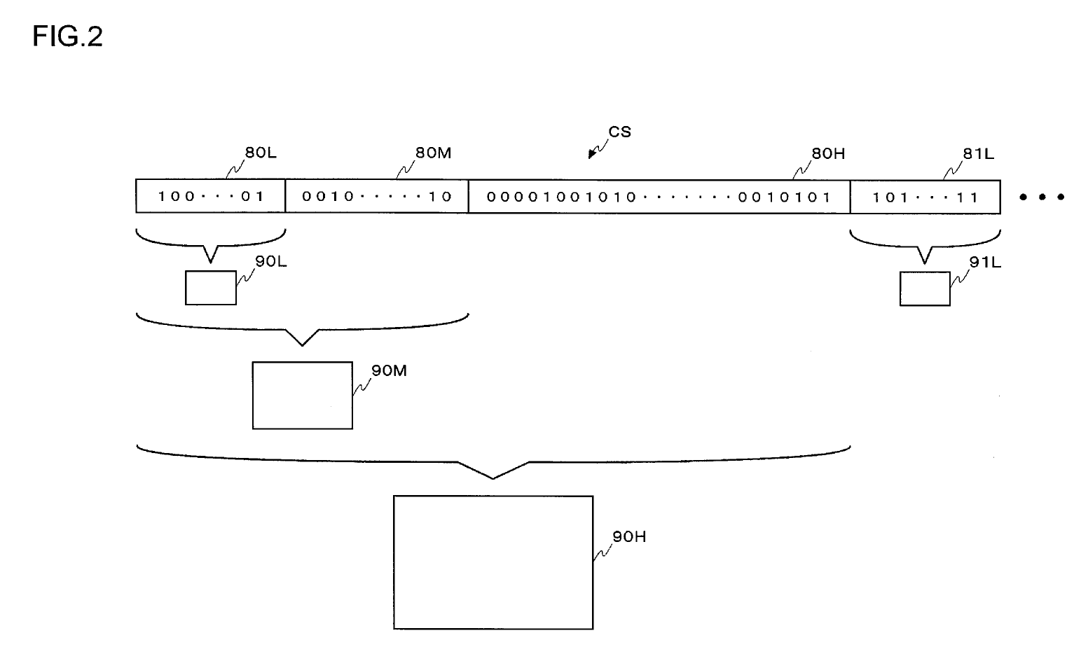

FIG. 2 illustrates a structure of a moving image codestream CS coded by the hierarchical coding unit 22. The moving image codestream CS as shown in FIG. 2 is a codestream which is spatially hierarchized, and is comprised of a lowest hierarchy, a middle-level hierarchy and a top hierarchy. Coded data 80L of the lowest hierarchy represents a basic hierarchy. Decoding the coded data 80L alone enables the production of a low-resolution image 90L.

Coded data 80M of the middle-level hierarchy and coded data 80H of the top hierarchy are coded data used to compensate for the low-resolution image 90L. A middle-resolution image 90M can be generated by decoding and restructuring the coded data 80L of the lowest hierarchy and the coded data 80M of the middle-level hierarchy. Similarly, a high-resolution image 90H can be generated by decoding and restructuring the coded data 80L of the lowest hierarchy, the coded data 80M of the middle-level hierarchy and the coded data 80H of the top hierarchy.

In the moving image codestream CS, code data comprised of a frame of the lowest hierarchy, a frame of the middle-level hierarchy and a frame of the top hierarchy are followed by coded data comprised of the next frame of the lowest hierarchy, the next frame of the middle-level hierarchy and the next frame of the top hierarchy. The similar data structure continues until the final frame.

According to the first embodiment as described above, the picked-up moving images are hierarchically coded; they are decoded up to a predetermined hierarchy when they are outputted externally; and the thus decoded images are recoded. As a result, the moving images picked up with high image quality can be simply and promptly sent to a device, which displays them with low image quality, in a reproducible state. Hence, the user can smoothly and stress-freely carry out the transfer processing to the external device and the write processing to the recording medium as if he or she is transferring the moving image coded data without subjecting them to recompression and recoding.

In other words, it is possible to obtain images of various levels of resolutions by recompression and recoding performed within the image pickup apparatus. Accordingly, recompression and recoding after transferring the image to the PC is no longer necessary, and the moving image coded data can be handed directly to the portable information terminal or the like in a state where they can be played back instantly.

Also, the hierarchized moving image coded data are recompressed and recoded, so that the high-speed conversion can be achieved. That is, where common moving image coded data are to be recompressed and recoded, the entire dada must be decoded and the resolution thereof must be converted. Then they must be recoded. In contrast thereto, in the present embodiment, only data necessary for the conversion may be decoded in the hierarchized moving image coded data. Thus, the amount of computation can be reduced. Also, no resolution conversion processing is required, so that the amount of computation therefor can also be reduced. As a result, in terms of the similar hardware resource and the software resource, the time required for recompression and recoding in the latter can be significantly reduced.

For example, consider a case where the moving image coded data of 1080i size (1920×1080 pixels) are recompressed and recoded to those of VGA size (640×480 pixels). If the moving image coded data of 1080i size are coded in compliance with the 264/AVC standard, the entire data need to be decoded. When the moving image coded data of 1080i size are coded in compliance with the H.264/SVC standard, it is sufficient that about ⅙ of the entire coded data be decoded for the same purpose and the 6× speed conversion is possible. Obviously, the time required for the recoding is the same for the both cases.

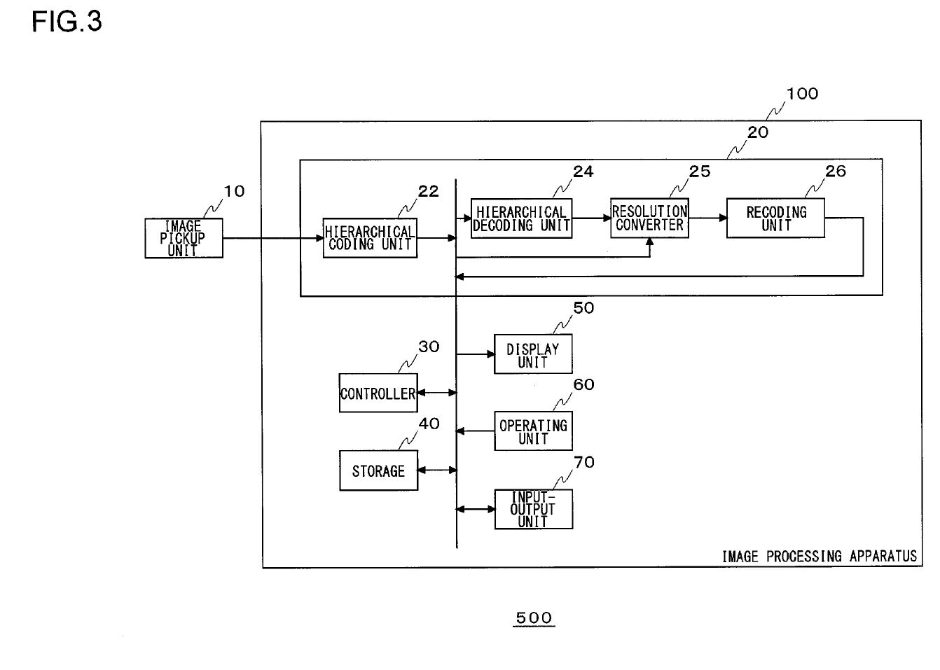

FIG. 3 illustrates a structure of an image pickup apparatus 500 according to a second embodiment. The structure of the image pickup apparatus 500 shown in FIG. 3 is such that a resolution converter 25 is added to the structure of the image pickup apparatus 500 of FIG. 1. A description is hereinbelow given of the second embodiment centering around differences from the first embodiment.

A coding unit 20 according to the second embodiment includes a hierarchical coding unit 22, a hierarchical decoding unit 24, a resolution converter 25, and a recoding unit 26. The hierarchical coding unit 22 hierarchically codes an image in such a manner that the image with the resolution of ½ⁿ (n being a natural number) of a picked-up image can be generated irrespectively of the resolutions set by versatile standards. For instance, an image of 1080i size (1920×1080 pixels) is coded in four hierarchies so that images of 1/16 (480×270 pixels), ¼ (960×540 pixels) and ½ (1357×764 pixels) can be generated.

The hierarchical decoding unit 24 decodes part of moving image coded data stored in a storage 40 and then generates moving images whose image quality is lower than the picked-up moving images. The hierarchical decoding unit 24 decodes the coded data from the lowest hierarchy up to a hierarchy having the resolution closest to that specified by the controller 30, in the moving image coded data which have been hierarchically coded. Here, the “resolution closest to that specified” is preferably the resolution closest thereto among those higher than the specified resolution. As a result, the image can be converted using a thinning-out processing in a resolution conversion processing discussed later. On the other hand, if selection is made from among the resolutions lower than the specified resolution, an interpolation processing will be required in the resolution conversion processing discussed later, thus increasing the amount of computation. However, this mode is not excluded from the exemplary embodiments of the present invention.

A concrete example is now described based on the above-described examples. When the VGA size (640×480 pixels) is specified by the controller 30, the hierarchical decoding unit 24 generates an image of ¼ (960×540 pixels) whose resolution is closest thereto among the resolutions higher than the specified resolution. More specifically, of the four hierarchies, the lowest hierarchy and a hierarchy higher than this lowest hierarchy are decoded and reconstructed so as to be able to generate an image which is ¼ (960×540 pixels) of an original image.

The resolution converter 25 converts the resolution of the moving images decoded by the hierarchical decoding unit 24. More specifically, the resolution of the moving images decoded by the hierarchical decoding unit 24 is converted to the resolution specified by the controller 30 and is sent to the recoding unit 26. In the above-described example, the image which is ¼ (960×540 pixels) of the original image is converted to an image of VGA (640×480 pixels). Note that a thinning-out processing or interpolation processing based on general algorithms may be used in the conversion processing. The recoding unit 26 codes once again the moving images whose resolution has been converted.

According to the second embodiment as described above, the same advantageous effects as with the first embodiment are achieved. Also, the provision of the resolution converter makes it possible to recompress and recode images even though the resolution thereof reproducible by the hierarchically coded moving image coded data does not fit to the resolution reproducible by the display unit. Thus, general versatility is improved.

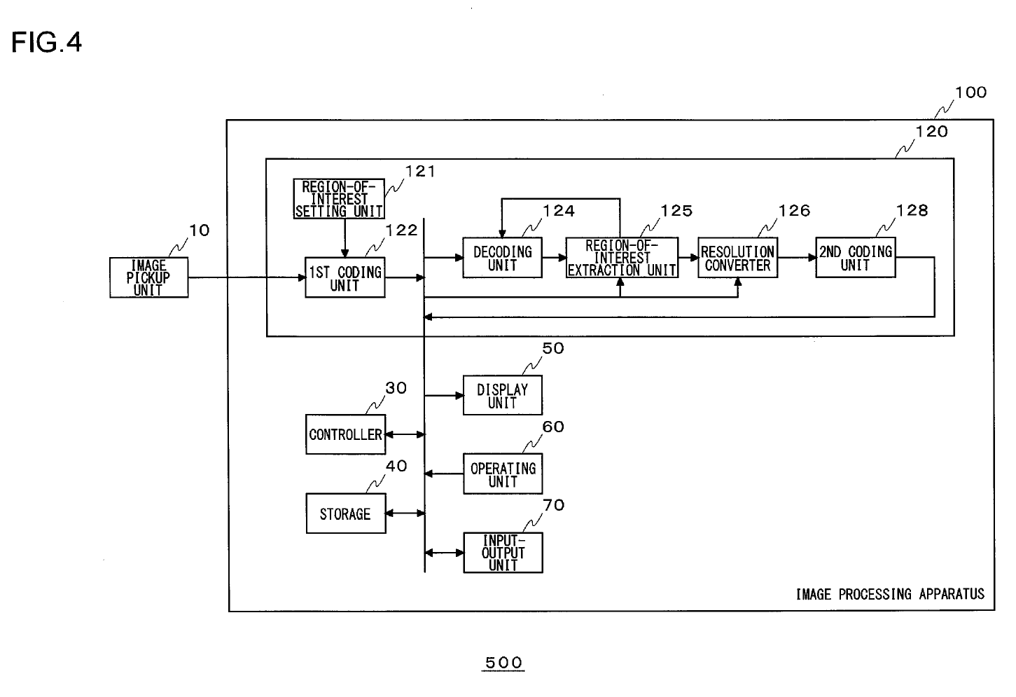

FIG. 4 illustrates a structure of an image pickup apparatus 500 according to a third embodiment. The structure of a coding unit 120 in the image pickup apparatus 500 shown in FIG. 4 differs from that of the coding unit 20 in the image pickup apparatus 500 shown in FIG. 1. A description is hereinbelow given of the third embodiment centering around differences from the first embodiment.

The coding unit 120 according to the third embodiment includes a region-of-interest setting unit 121, a first coding unit 122, a decoding unit 124, a region-of-interest extraction unit 125, a resolution converter 126, and a second coding unit 128.

The region-of-interest setting unit 121 sets a region of interest (hereinafter referred to as simply “ROI” also) in a picture contained in the moving images picked up by the image pickup unit 10. Here, “picture” means a unit of coding, and the concept thereof may include a frame, a field, a VOP (Video Object Plane) and the like.

The region-of-interest setting unit 121 separates an object of interest from the background and sets a region containing part of the object or the entire object as a region of interest (ROI). For example, where a face detection function or moving body detection function is mounted on the image pickup apparatus 500, the region containing part of the object or the entire object detected by such functions is set as a ROI. The size of ROI may be fixed or variable. Where fixed, it is desirable that the size be adjusted to versatile standard sizes such as QVGA size (320×240 pixels) or VGA size (640×480 pixels). Where variable, the size of a ROI containing the object of interest is adaptively varied according to the size of the object relative to the screen. For example, if the object is a person, the size of a ROI will be set larger as the person is displayed on the screen in a zoomed-in manner.

The region-of-interest setting unit 121 does not set the ROI for a frame where no object of interest can be detected. Also, it is not absolutely necessary to set regions of interest for all frames, and the ROI may be set to every some frames such as one other frame. Also, the position and the size of the ROI may be changed for every some frames.

Where ROIs are set, the region-of-interest setting unit 121 describes the positional information on the ROIs in a header of the frame or in a region specified by the header. Where the size of ROI is varied, the size information thereon is also described. For example, the positional information and the size information on the ROI can be defined by upper-left vertex coordinates of the ROI and the distance and width measured from the vertex coordinates. The central coordinates and the like may be used instead of the vertex coordinates.

The first coding unit 122 codes the moving images picked up by the image pickup unit 10. The moving image coded data coded by the first coding unit 122 contain pictures where the above-described ROIs are set. The first coding unit 122 may code them using the H.264/AVC standard, may hierarchically code them using the H.264/SVC standard, or may code them using any other standards.

The decoding unit 124 decodes at least the coded data of a ROI or the coded data of a partial region of the ROI in a picture contained in the moving image coded data stored in the storage 40. The decoding unit 124 may decode the entire region of each frame or may decode only a ROI within each frame or only a certain region containing the ROI within each frame according to an instruction from the region-of-interest extraction unit 125. Also, according to an instruction from the region-of-interest extraction unit 125, the decoding unit 124 may decode a predetermined region within the ROI, which is only a region of VGA size (640×480 pixels), for instance.

In a case when the position of a ROI can be specified prior to the decoding of each ROI, the ROI only or only a predetermined region of the ROI can be decoded. Such a case as described above includes a case where the positional information of a ROI of each frame is described all together in the header of the moving image coded data and a case where the positional information of each frame is recorded in another separate file. If the positional information on each ROI is specified in a header of each frame or the header, it will be realistic to carry out the processing of decoding the entire region of each frame.

Where moving image coded data to be decoded are hierarchically coded data, the decoding unit 124 decodes part of said moving image coded data starting from the coded data in the lowest hierarchy up to those at a hierarchy specified by the controller 30. It is to be noted that the positional information on a ROI is coded in an image at each hierarchy in a specifiable manner.

When a write instruction to a detachable recording medium or a transfer instruction to an external device is issued, the decoding unit 124 reads out the moving image coded data from the storage 40 and decodes them.

The region-of-interest extraction unit 125 refers to the positional information on the ROI contained in the above-mentioned moving image coded data and then extracts or specifies the ROIs from within the entire region of pictures decoded by the decoding unit 124. The region-of-interest extraction unit 125 extracts regions corresponding to the resolution specified by the controller 30, from within the extracted or specified region of interest.

A case is hereinbelow considered where the controller 30 specifies that a region of VGA size (640×480 pixels) be extracted. In accordance with marked points within the extracted or specified region of interest, the region-of-interest extraction unit 125 can extract a region of limited size. As a result, the sizes of a plurality of regions-of-interest thus extracted can be matched with each other. An upper-left vertex of a ROI, a midpoint of an upper side line of a ROI or a midpoint within a ROI can be used as the marked point.

For example, when the upper-left vertex is a marked point, a region having the specified number of pixels emanating horizontally and vertically from the upper-left vertex is extracted. When the midpoint within the ROI is a marked point, the region is extracted in a manner such that the midpoint thereof coincides with the midpoint of a region of the specified size. Such a processing as described above is used mainly in the case when the size of a ROI is variable. At the same time, where the size thereof is fixed, such a processing as described above may also be used if the size of the ROI differs from the specified size.

The region-of-interest extraction unit 125 performs any one of the following three processings on a frame where the ROI has not been set. The first processing is that the positional information on the ROI in other frames, for example, a frame immediately before said frame, is so diverted that this position is regarded as the position of the ROI in the frame where no ROI has been set. The second processing is that the entire region of the frame is set as the ROI. Third processing is that the frame where no ROI has been set is skipped and the only frames where ROIs have been set are sent to the resolution converter 126 and the second coding unit 128.

The resolution converter 126 converts the resolution of the ROI decoded by the decoding unit 124 into the resolution specified by the controller 30 so as to be delivered to the second coding unit 128. If a structure is such that the size of a region extracted from each picture is made identical by the processing performed by the region-of-interest extraction unit 125, the provision of the resolution converter 126 will not be necessary. The resolution converter 126 is provided in the case when a structure is such that the size of ROIs is not adjusted by the region-of-interest extraction unit 125.

The resolution converter 126 enlarges or reduces the size of at least one ROI so that the enlarged or reduced size thereof can be fitted to the size of each ROI in each of a plurality of pictures contained in the picked-up moving images. The enlarging processing is performed by an interpolation processing, whereas the reducing processing is performed by a predetermined thinning-out processing. As a result, the sizes of a plurality of ROIs extracted can be made equal to one another.

The second coding unit 128 recodes the ROI decoded by the decoding unit 124 or the partial region of the ROI. For instance, the ROI or the partial region of the ROI is compressed and coded using the H.264/AVC standard. In accordance with the instruction from the controller 30, the second coding unit 128 transfers the coded H.264-compressed data to the external device or writes them to the removable recording medium via the input-output unit 70. Note that said H.264-compressed data may be stored in the storage 40.

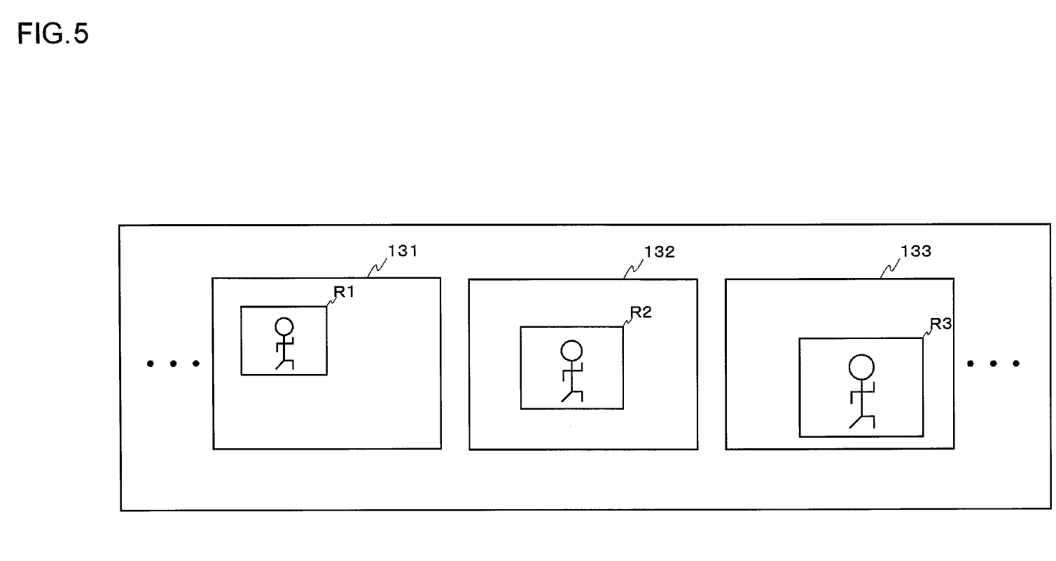

FIG. 5 shows an example of moving images where regions of interest are set in the moving images. A first frame 131, a second frame 132, and a third frame 133 constitute the moving images and are drawn in order of time (left to right). In the first frame 131, the second frame 132 and the third frame 133, a person is an object to be marked. And a region surrounding the object is set as an region of interest in each of the frames. The person whose image is picked up runs in a direction from a left rear towards a front in the right side. Along with this, the position of the ROI and the size thereof varies.

The region-of-interest extraction unit 125 extracts a region of interest R1 of the first frame 131, a region of interest R2 of the second frame 132, and a region of interest R3 of the third frame 133. The second coding unit 128 codes the thus extracted regions so as to generate new moving image coded data. In so doing, the region-of-interest extraction unit 125 may extract a region of the specified size from within the region of interest. Or resolution converter 126 may adjust the size of the extracted region of interest.

According to the third embodiment as described above, the picked-up moving images are coded, and when the thus coded moving images are outputted externally, a ROI of the coded moving images or a partial region thereof is extracted therefrom so as to be recoded. As a result, the moving images picked up with high image quality can be simply and promptly sent to a device, which displays them with low image quality, in a reproducible state. Since recoded are the moving images with the background removed while the ROI thereof remains, the moving images can be reproduced by the low-resolution display device without the deterioration in the image quality of the object. Besides, the percentage of area of the object occupied in the entire image can be raised, so that the situation where the object is displayed in a small size because of the images picked up with high image resolution can be prevented.

By combining the third embodiment with the first embodiment or the second embodiment, a ROI or partial region thereof is extracted from the hierarchically coded moving image coded data so as to be recoded. As a result, the resolution can be adjusted in two stages and therefore the images can be finely adjusted. Also, the region-of-interest extraction unit 125 extracts the ROI or partial region thereof from within a frame whose image quality is lower than that of the original image, and the second coding unit 128 codes the thus extracted region. As a result, the moving images can be converted to those reproducible by the low-resolution display device in a smaller amount of time.

The present invention has been described based on three embodiments. These embodiments are merely exemplary, and it is understood by those skilled in the art that various modifications to the combination of each component and each process thereof are possible and that such modifications are also within the scope of the present invention.

For instance, when temporal hierarchical coding is performed by the hierarchical coding unit 22, the moving image coded data excluding bidirectional frames (B frames) or B frames and predictive frames (P frames) are reproduced by the recoding unit 26. The portable information terminal reproduces the moving image coded data whose number of frames is smaller than that of the original moving image coded data. Thereby, the amount of computation can be reduced and the power consumed by the portable information terminal can be reduced.

What is claimed is:

1. An image processing apparatus, comprising:
a region-of-interest setting unit which sets a region of interest in a picture contained in a picked-up moving image;
a first coding unit which codes the moving image containing the picture to which the region of interest has been set;
a storage which stores moving image coded data which have been coded by said first coding unit;
a decoding unit which decodes at least coded data of the region of interest or coded data of a partial region of the region of interest in the picture contained in the moving image coded data; and
a second coding unit which codes the region of interest or the partial region of the region of interest decoded by said decoding unit.

2. An image processing apparatus according to claim 1, further comprising a region-of-interest extraction unit which extracts the region of interest from within the picture decoded by said decoding unit, by referring to positional information, on the region of interest, contained in the moving image coded data,
wherein said region-of-interest setting unit adaptively varies the size of a region of interest focused on an object according to the size of the object relative to a screen, and
wherein said region-of-interest extraction unit extracts a region corresponding to a specified resolution, from within the region of interest.

3. An image processing apparatus according to claim 1, further comprising:
a region-of-interest extraction unit which extracts the region of interest from within the picture decoded by said decoding unit, by referring to positional information, on the region of interest, contained in the moving image coded data; and
a resolution converter which converts the resolution of the region-of-interest decoded by said decoding unit into a specified resolution,
wherein said region-of-interest setting unit adaptively varies the size of a region of interest focused on an object according to the size of the object relative to a screen, and
wherein said resolution converter enlarges or reduces the size of at least one region of interest in such a manner that the enlarged or reduced size thereof is fitted to the size of each region of interest in each of a plurality of pictures contained in the moving image.

4. An image processing apparatus according to claim 2, wherein said first coding unit hierarchically codes the moving image containing the picture where the region of interest is set,
wherein said decoding unit decodes the moving image coded data starting from a lowest hierarchy up to a specified hierarchy, and
wherein said region-of-interest extraction unit extracts the region of interest from within a picture whose image quality is lower than an original image.

5. An image processing apparatus according to claim 3, wherein said first coding unit hierarchically codes the moving image containing the picture where the region of interest is set,
wherein said decoding unit decodes the moving image coded data starting from a lowest hierarchy up to a specified hierarchy, and
wherein said region-of-interest extraction unit extracts the region of interest from within a picture whose image quality is lower than an original image.

6. An image processing apparatus according to claim 1, wherein upon receiving a write instruction to a detachable recording medium or a transfer instruction to an external device, said decoding unit reads out the moving image coded data from said storage so as to decode the moving image coded data.

7. An image processing apparatus according to claim 2, wherein upon receiving a write instruction to a detachable recording medium or a transfer instruction to an external device, said decoding unit reads out the moving image coded data from said storage so as to decode the moving image coded data.

8. An image processing apparatus according to claim 3, wherein upon receiving a write instruction to a detachable recording medium or a transfer instruction to an external device, said decoding unit reads out the moving image coded data from said storage so as to decode the moving image coded data.

9. An image processing apparatus according to claim 4, wherein upon receiving a write instruction to a detachable recording medium or a transfer instruction to an external device, said decoding unit reads out the moving image coded data from said storage so as to decode the moving image coded data.

10. An image processing apparatus according to claim 5, wherein upon receiving a write instruction to a detachable recording medium or a transfer instruction to an external device, said decoding unit reads out the moving image coded data from said storage so as to decode the moving image coded data.

11. An image pickup apparatus, comprising:
image pickup devices; and
an image processing apparatus, according to claim 1, which codes a moving image picked up said image pickup devices.

12. An image processing apparatus, comprising:
a hierarchical coding unit which hierarchically codes a picked-up moving image;
a storage which stores moving image coded data which have been coded by said hierarchical coding unit;
a hierarchical decoding unit which decodes part of the moving image coded data so as to generate a moving image whose image quality is lower than the moving image; and
a recoding unit which codes the moving image decoded by said hierarchical decoding unit.

13. An image processing apparatus according to claim 12, wherein said hierarchical decoding unit decodes the moving image coded data starting from a lowest hierarchy up to a hierarchy corresponding to a specified resolution.

14. An image processing apparatus according to claim 12, further comprising a resolution converter which converts the resolution of the moving image decoded by said hierarchical decoding unit,
wherein said hierarchical decoding unit decodes the moving image coded data starting from a lowest hierarchy up to a hierarchy having a resolution closest to a specified resolution, and
wherein said resolution converter converts the resolution of the moving image decoded by said hierarchical decoding unit into the specified resolution and outputs the moving image, whose resolution has been converted, to said recoding unit.

15. An image processing apparatus according to claim 12, wherein upon receiving a write instruction to a detachable recording medium or a transfer instruction to an external device, said hierarchical decoding unit reads out the moving image coded data from said storage so as to decode the moving image coded data.

16. An image processing apparatus according to claim 13, wherein upon receiving a write instruction to a detachable recording medium or a transfer instruction to an external device, said hierarchical decoding unit reads out the moving image coded data from said storage so as to decode the moving image coded data.

17. An image processing apparatus according to claim 14, wherein upon receiving a write instruction to a detachable recording medium or a transfer instruction to an external device, said hierarchical decoding unit reads out the moving image coded data from said storage so as to decode the moving image coded data.

18. An image pickup apparatus, comprising:
image pickup devices; and
an image processing apparatus, according to claim 12, which codes a moving image picked up by said image pickup devices.
